(19) United States
(12) Patent Application Publication
(10) Pub. No.: US 2003/0118795 A1
(43) Pub. Date: Jun. 26, 2003

(54) Mattress label system

(76) Inventors: Thomas E. Wright, Greensboro, NC (US); Ronald E. Wright, High Point, NC (US)

Correspondence Address: C. Robert Rhodes, Womble Carlyle Sandridge & Rice, PLLC, Suite 1900, 300 N. Greene Street, Greensboro, NC, 27401, US

(21) Appl. No.: 10/366,239

(22) Filed: Feb. 13, 2003

Related U.S. Application Data
(62) Division of application No. 09/552,954, filed on Apr. 20, 2000.

(51) Int. Cl. B41M 5/00

(52) U.S. Cl. 428/195

(57) ABSTRACT

A mattress label system. The mattress includes: an internal support; a cover; and a unique label attached to the cover. In the preferred embodiment, the label includes: a label stock; an ink jet receptive coating; generic product indicia printed onto the label; and a residual print receptive region for receiving mattress specific indicia; and a clear coating covering substantially the surface of the label except the residual print receptive region. After the label is formed with the generic indicia, mattress specific indicia is added at about the time the mattress is completed onto the residual print receptive region, thereby eliminating multiple SKUs for different specific mattresses.

### BACKGROUND OF THE INVENTION

(1) Field of the Invention

The present invention relates generally to bedding, and more particularly, to a mattress labeling system which allows generic ink jet receptive labels to be used for many different product SKUs.

(2) Description of the Related Art

Because mattresses are so bulky and expensive to ship, the manufacture of mattresses is highly distributed or franchised. The home office gives the local franchisee the specifications and the local franchisee goes out and buys the raw goods/basic materials. The home office generally only contracts for the major items like the cover material and labels. Thus, when a consumer buys a mattress from Serta, for example, he is actually buying a mattress from a local franchisee which is just one of 25 franchise manufactures of the Serta Perfect Sleeper mattress line. This saves the home office distribution costs and the local franchisee gets national advertising. This is critical in the home furnishings business because most consumers buy based on mattress label.

There are over 5,000 different mattress model names in the market place. As the regional markets became more diversified, each retail store chain now expects its own personal model name. Consequently, each manufacturer of mattresses has had to come up with private names and keep increasingly extensive label inventories. However, labels are expensive and long led time items, which may become worthless if there is a minor change in name or labeling. Manufacturers do not want large inventories of model specific labels or the costs associated with them.

Thus, there remains a need for a generic print receptive label for a mattress which can be used for many different product SKUs while, at the same time, retains the quality and durability come to be expected for high quality, high end mattresses.

### SUMMARY OF THE INVENTION

The present invention is directed to a mattress label system. The mattress includes: an internal support; a cover; and a unique label attached to the cover. In the preferred embodiment, the label includes: a label stock; an ink jet receptive coating; generic product indicia printed onto the label; and a residual print receptive region for receiving mattress specific indicia; and a clear coating covering substantially the surface of the label except the residual print receptive region. In the preferred embodiment, the clear coating is UV cured and has a crock value of at least 25 strokes and, in the preferred embodiment, greater than about 50 strokes when tested on an ASTM Crock Meter.

The mattress is generally of conventional construction and the internal support may be an inner spring or foam. The cover includes a top surface, a border, and a tape edge for attaching the top surface to the border.

In the preferred embodiment, the label stock is a tightly woven fabric, such as a polyester satin weave fabric having greater than about 228 fill ends and about 46 warp ends. The label may further include a vinyl back coating which, in turn, may include an opacifying agent, such as titanium dioxide.

In the preferred embodiment, the print receptive coating is a hydrophilic coating, which is a mixture of water suspended polymer and colloidal silica. The coating may further include a primer coating of silica and acrylic between the ink jet receptive mixture and the indicia.

After the label is formed with the generic indicia, mattress specific indicia is added at about the time the mattress is completed onto the residual print receptive region, thereby eliminating multiple SKUs for different specific mattresses.

Accordingly, one aspect of the present invention is to provide a mattress label system. The mattress includes an internal support; a cover; and an ink jet receptive label attached to the cover.

Another aspect of the present invention is to provide a print receptive label for a mattress. The label includes: a label stock; a print receptive coating; generic product indicia printed on to the print receptive coating; and a residual print receptive region for receiving mattress specific indicia.

Still another aspect of the present invention is to provide a mattress label system. The mattress includes: an internal support; a cover; a label attached to the cover, the label including: a label stock; an ink jet receptive coating; generic product indicia printed onto the label; and a residual ink jet print receptive region for receiving mattress specific indicia; and a clear coating covering substantially the surface of the label except the residual print receptive region.

These and other aspects of the present invention will become apparent to those skilled in the art after a reading of the following description of the preferred embodiment when considered with the drawings.

### BRIEF DESCRIPTION OF THE DRAWINGS

FIG. 1 is a perspective view of a mattress label system constructed according to the present invention;

FIG. 2 is an enlarged top view of the label shown in FIG. 1;

FIG. 3 is an enlarged cross-sectional view of the label shown in FIG. 2 taken along lines 3-3;

FIG. 4 is an enlarged top view of a label similar to that shown in FIG. 2 illustrating defective regions; and

FIG. 5 is a flow chart illustrating the method of doing business between the home office and the local manufacturer.

### DESCRIPTION OF THE PREFERRED EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

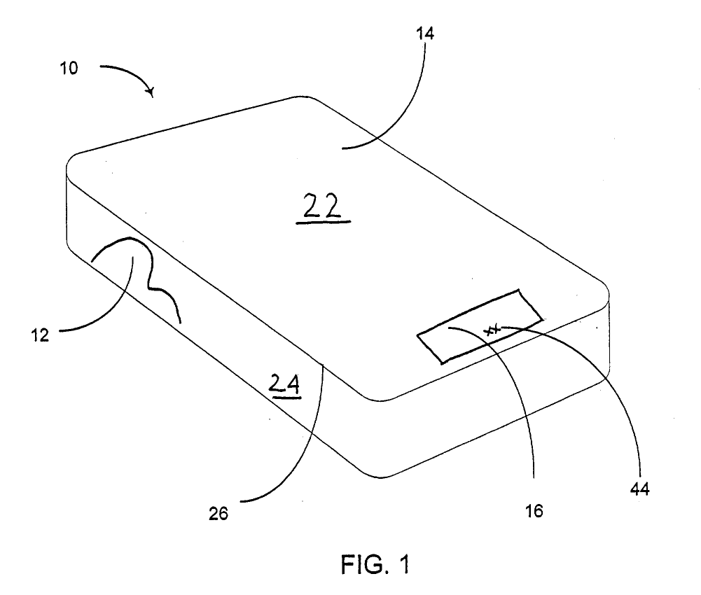

As best seen in FIG. 1, there is shown a mattress labeling system, generally designated 10, constructed according to the present invention. Mattress labeling system 10 includes a generally conventional mattress having an internal support 12, a cover 14, an ink jet receptive label 16 and a clear coating 20 overlaying substantially all of the ink jet receptive label 16 except for a residual, print receptive region 44 for receiving specific product labeling unique to a particular mattress model.

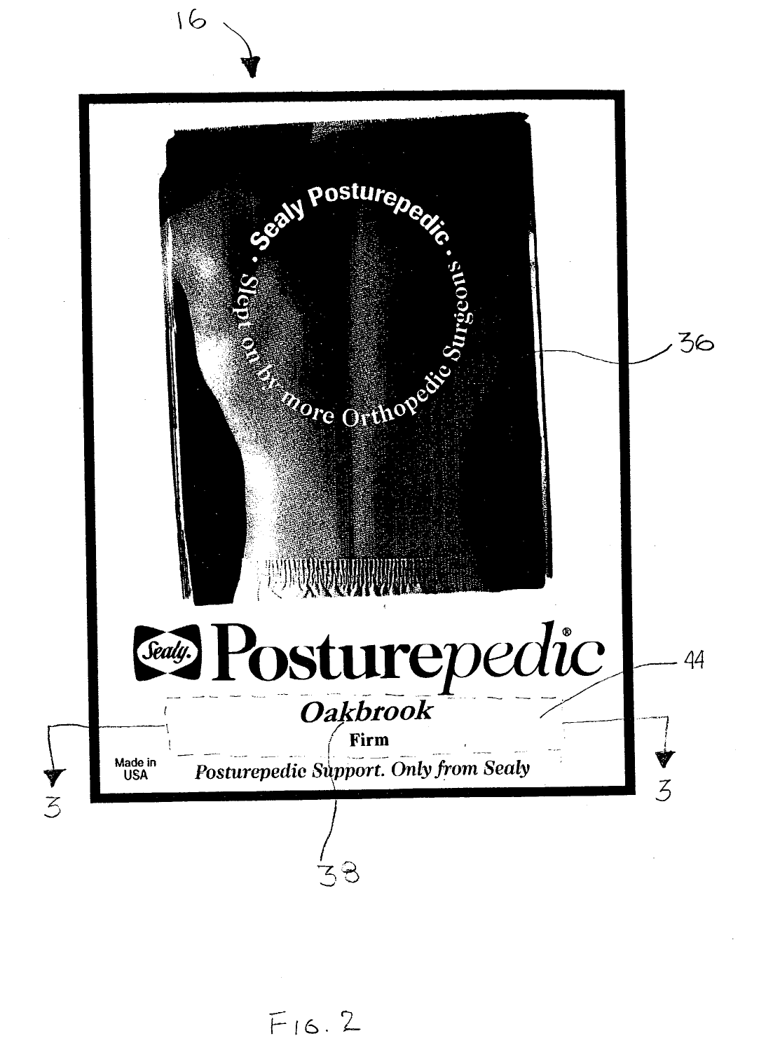

As may also be seen in FIG. 1, mattress 10 may include further internal support such as an inner spring arrangement or a closed or open cell foam arrangement. Cover 14 is also generally conventional in construction and includes a top surface 22, a border section 24 and a tape edge 26 attaching the two together. As best seen in FIG. 2, ink jet receptive label 16 includes a residual, print receptive region 44 for. receiving printed indicia 38 describing the specific product after the label is formed and preferably prior to the label being attached to the final mattress.

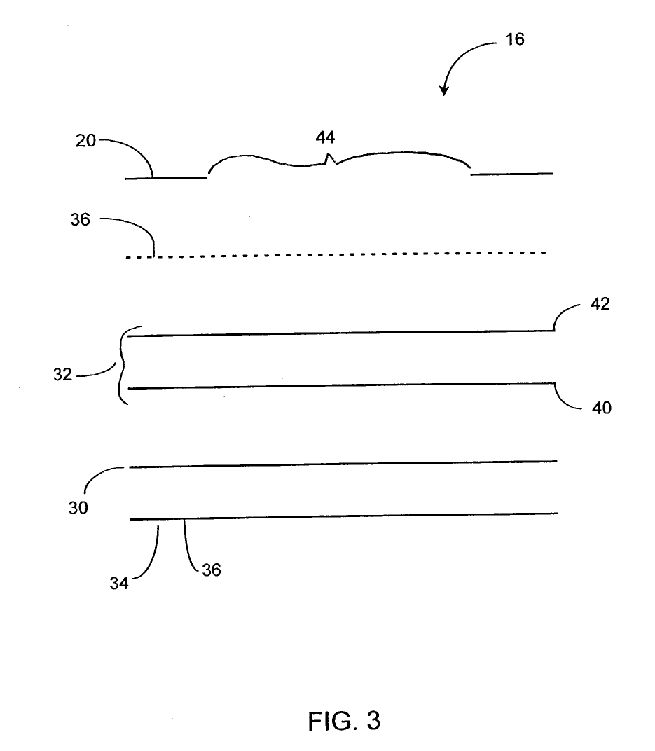

As can best be seen in FIG. 3, there is shown an enlarged cross-sectional view of the label 16 shown in FIG. 2 taken along line 3-3. Print receptive label 16 includes a label stock 30, which further includes a back coating 34 to stabilize the label stock 30. In the preferred embodiment, label stock 30 is a tightly woven, satin weave polyester fabric. In the preferred embodiment, the tightly woven polyester material is 150 d warp×70 d fill with about 228 ends in the fill direction and 46 ends in the warp direction. It has been found that having less than about 200 ends in the fill direction produces a label stock 30 which is too loosely woven to receive the coating. Also, in the preferred embodiment, the back coating 34 is a conventional acrylic coating to which an opacity agent 36, such as titanium dioxide, may be added. Acrylic coating 34 serves both to stabilize the label stock 30 and to add to the perceived quality of the label.

In the preferred embodiment, the print receptive coating 32 of the present invention is a hydrophilic ink jet receptive coating. In the preferred embodiment, coating 32 includes a primer layer 40 of silica and acrylic overlaid with an ink jet receptive coating 42 of a water suspended polymer and colloidal silica. In the preferred embodiment, a single, combined coating may be applied. One source of such a suitable coating may be purchased from Rayven Incorporated of St. Paul, Minn., under the designation Semi-Matte, Ink Jet coating.

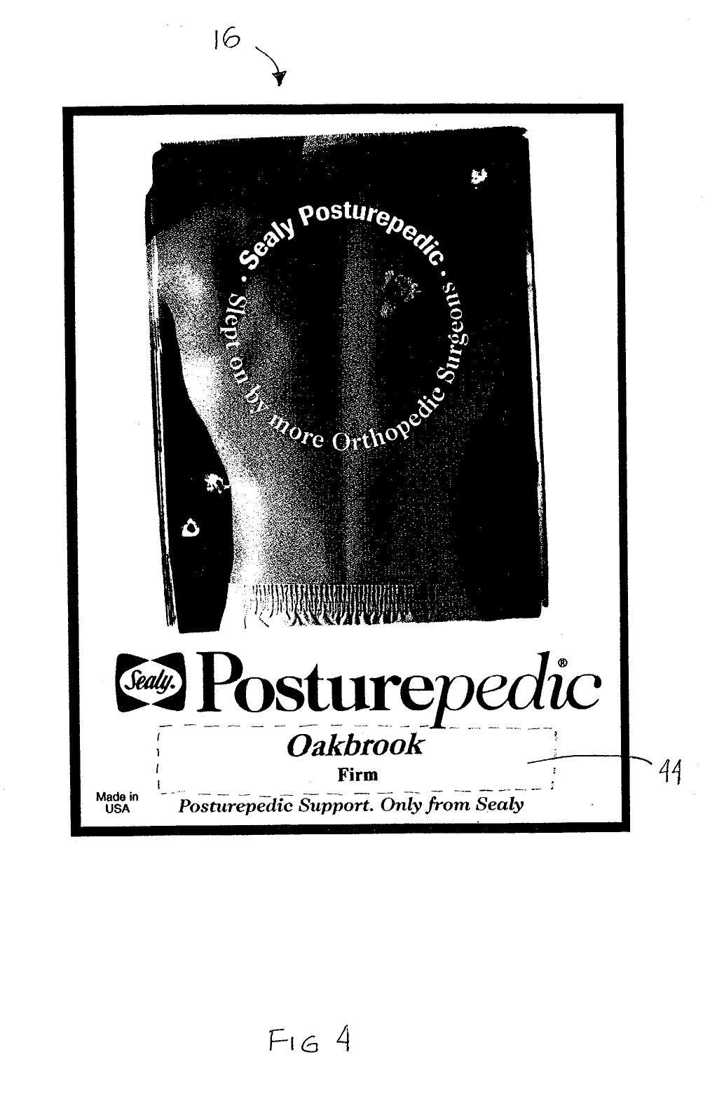

As best seen in FIG. 2, print receptive coating 32 is first printed with generic indicia 36 for the mattress and manufacturer, which may be utilized for a multitude of styles of the mattress. This indicia may be ink jet printed directly onto the print receptive coating 32. After printing, a clear coat 20 is applied over top the generic indicia 36 which is UV cured to prevent the generic indicia 36 from being damaged during later handling (see FIG. 4 for examples of defects formed without the protective coating).

In the preferred embodiment, a residual, print receptive region 44, is left clear coating 20 free to permit the mattress manufacture to add mattress specific indicia 38, such as SKU information, onto the mattress label which may be added at the plant for even just one particular mattress which is being made.

Clear coating 20 is preferably UV Matt from Creative Screen of Charlotte, N.C. It has been found that such a clear coating, when UV cured, has a label crock value of greater than about 50 strokes when tested on an ASTM Crock Meter. Thus, the coated, generic indicia 36 portion of the label is substantially crock-free. A comparison of FIGS. 2 and 4 shows the importance of such protection. Without a satisfactory coating 20, the underlying generic indicia 36 may be easily damaged.

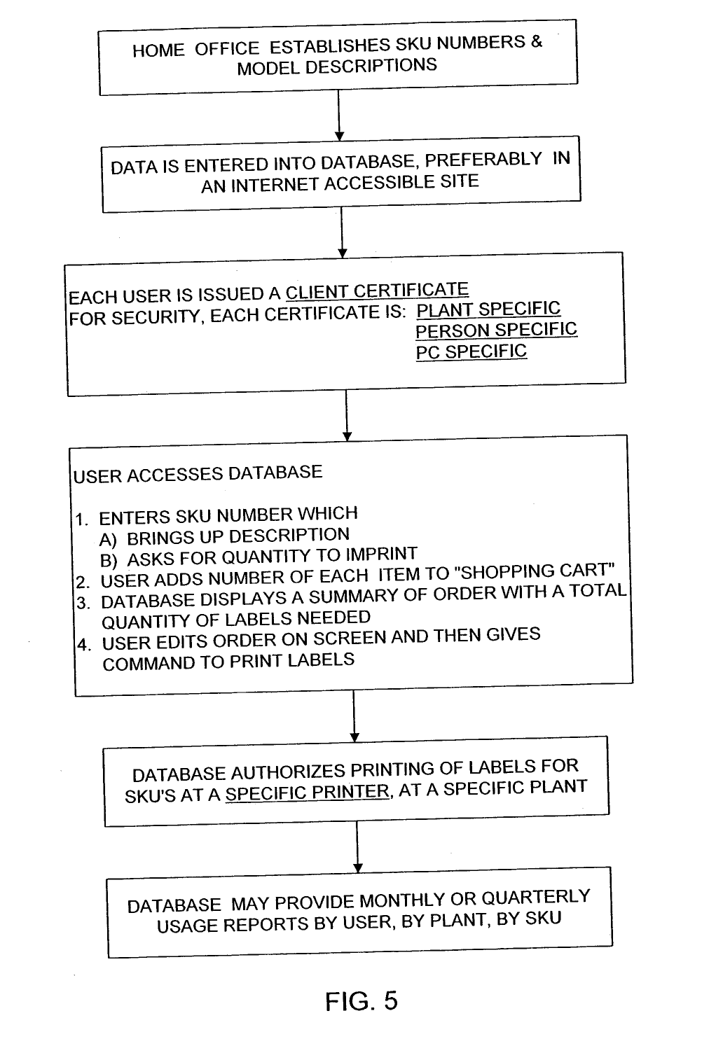

In operation, if a local mattress manufacturer for a regional retail chain gets an order for 15 mattresses, the present invention enables the manufacturer to imprint just the 15 model labels. As can be seen in FIG. 5, in the preferred embodiment, the manufacture accesses a database, such as on a web page site whereby a manufacturer, accesses their SKU part of the data, for example 10 Elite, 10 Ambassador, etc. The database then authorizes the printer at the plant to print those particular SKUs.

This information can also be reported back to the home office since much of the bedding business is franchised. This will allow the franchiser or a national company to check his model information back against the plant's reported consumption by model name. This acts as a further verification that the home office is controlling the model name and specification which it is entitled while, at the same time, integrates the control of the label printing into the home office's business information.

Certain modifications and improvements will occur to those skilled in the art upon a reading of the foregoing description. By way of example, while acrylic coating is the preferred embodiment, vinyl coatings, such as heat cured vinyl coatings, could also be used on the back side of the fill. Also, while ink jet printing is the preferred embodiment because the label stock adsorbs much of the ink, thereby providing greater crock resistance, laser printing of the label could be used for articles where very high crock resistance is not needed. Finally, while the method of operation shown in FIG. 5 is for internal use between a home office and a remote manufacturer, a third party provider could also provide the service to the home office and remote manufacturer. It should be understood that all such modifications and improvements have been deleted herein for the sake of conciseness and readability but are properly within the scope of the following claims.

We claim:

1. A mattress label system, said mattress comprising:
(a) an internal support;
(b) a cover; and
(c) a ink jet receptive label attached to said cover.

2. The mattress labeling system according to claim 1, wherein said ink jet receptive label further including a clear coating.

3. The mattress labeling system according to claim 2, wherein said clear coating is UV cured.

4. The mattress labeling system according to claim 2, wherein said clear coating has a crock value of greater than about 50 strokes.

5. The mattress labeling system of claim 1, wherein said internal support is an inner spring.

6. The mattress labeling system according to claim 1, wherein said internal support is foam.

7. The mattress labeling system of claim 1, wherein said cover includes a top surface, a border, and a tape edge for attaching said top surface to said border.

8. A print receptive label for a mattress, said label comprising:
(a) a label stock;
(b) a print receptive coating;
(c) generic product indicia printed on to said print receptive coating; and
(d) a residual ink jet print receptive region for receiving mattress specific indicia.

9. The label according to claim 8, wherein said label stock is a tightly woven fabric.

10. The label according to claim 9, wherein said label stock is a polyester satin weave fabric.

11. The label according to claim 9, wherein said tightly woven fabric has greater than about 200 fill ends.

12. The label according to claim 11, wherein said tightly woven fabric has about 228 fill ends and about 46 warp ends.

13. The label according to claim 8, further including a back coating.

14. The label according to claim 13, wherein said back coating is an acrylic coating.

15. The label according to claim 13, wherein said back coating further includes an opacifying agent.

16. The label according to claim 15, wherein said opacifying agent is titanium dioxide.

17. The label according to claim 8, wherein said print receptive coating is a hydrophilic coating.

18. The label according to claim 17, wherein said hydrophilic coating is an ink receptive mixture of water suspended polymer and colloidal silica.

19. The label according to claim 18, further including a primer coating of silica and acrylic between said ink jet receptive mixture and said indicia.

20. A mattress label system, said mattress comprising:
(a) an internal support;
(b) a cover;
(c) a label attached to said cover, said label including: a label stock; an ink jet receptive coating; generic product indicia printed onto said label; and a residual print receptive region for receiving mattress specific indicia; and
(d) a clear coating covering substantially the surface of said label except said residual print receptive region.

21. The mattress labeling system according to claim 20, wherein said clear coating is UV cured.

22. The mattress labeling system according to claim 20, wherein said clear coating has a crock value of greater than about 50 strokes.

23. The mattress labeling system of claim 20, wherein said internal support is an inner spring.

24. The mattress labeling system according to claim 20, wherein said internal support is foam.

25. The mattress labeling system of claim 20, wherein said cover includes a top surface, a border, and a tape edge for attaching said top surface to said border.

26. The label according to claim 20, wherein said label stock is a tightly woven fabric.

27. The label according to claim 26, wherein said label stock is a polyester satin weave fabric.

28. The label according to claim 26, wherein said tightly woven fabric has greater than about 228 fill ends.

29. The label according to claim 28, wherein said tightly woven fabric has about 285 fill ends and about 46 warp ends.

30. The label according to claim 20, further including a back coating.

31. The label according to claim 30, wherein said back coating is an acrylic coating.

32. The label according to claim 30, wherein said back coating further includes an opacifying agent.

33. The label according to claim 32, wherein said opacifying agent is titanium dioxide.

34. The label according to claim 20, wherein said print receptive coating is a hydrophilic coating.

35. The label according to claim 30, wherein said hydrophilic coating is an ink receptive mixture of water suspended polymer and colloidal silica.

36. The label according to claim 35, further including a primer coating of silica and acrylic between said ink jet receptive mixture and said indicia.

37. A method for constructing a mattress having a label system, said method comprising the steps of:
(a) constructing an internal support;
(b) covering said internal support with a cover; and
(c) attaching an ink jet receptive label to said cover.

38. A method for producing a print receptive label for a mattress, said method comprising the steps of:
(a) forming a label stock;
(b) applying a print receptive coating to one surface of said label stock;
(c) printing generic product indicia on to said print receptive coating; and
(d) providing a residual ink jet print receptive region for receiving mattress specific indicia.

40. A method for constructing a mattress having a label system, said method comprising the steps of:
(a) constructing an internal support;
(b) covering said internal support with a cover;
(c) attaching a label to said cover, said label including: a label stock; an ink jet receptive coating; generic product indicia printed onto said label; a residual print receptive region for receiving mattress specific indicia; and a clear coating covering substantially the surface of said label except said residual print receptive region.

41. A method for providing a label for an article of manufacture which has a plurality of model designations, said article of manufacture having an outer surface for receiving said label, said method comprising the steps of:
(a) inputting SKU number and article specific indicia into a database for each model of said article;
(b) providing a user specific password to access said database, whereby said user accesses said database and enters the SKU number of a specific article and the number of labels required; and
(c) providing printing instructions to print said labels to a printer associated with said user; wherein said label including: a label stock; a print receptive coating; generic product indicia printed onto said label; and a residual print receptive region for receiving said article specific indicia.
